(19) United States
(12) Patent Application Publication
(10) Pub. No.: US 2024/0426613 A1
(43) Pub. Date: Dec. 26, 2024

(54) UNDERWATER INSPECTION UTILIZING ENVIRONMENTAL FACTORS IN SELECTING NAVIGATIONAL PATH

(71) Applicant: International Business Machines Corporation, Armonk, NY (US)

(72) Inventors: Rachana Vishwanathula, Hyderabad (IN); Rahul Reddy Ravipally, Bengaluru (IN); Shanmugaraja Selvam, Ariyalur (IN); Saranga dhar Tripathy, Hyderabad (IN)

(21) Appl. No.: 18/214,144

(22) Filed: Jun. 26, 2023

(51) Int. Cl. G01C 21/20

(52) U.S. Cl. CPC G01C 21/20

(57) ABSTRACT

A computer-implemented method, computer program product, and/or computing system for providing a navigational path to an underwater robot for performing an underwater inspection is provided that includes determining one or more potential navigational paths to be undertaken by an underwater robot when traveling from a starting point to a finish point; determining an impact area of the underwater robot for each potential navigational path based upon a size and movement of the underwater robot along each respective potential navigational path; using a marine habitat map to avoid sensitive areas in an underwater ecosystem while the underwater robot travels along each of the one or more potential navigational paths; determining a navigational path from the one or more potential navigational paths that minimizes environmental impact to the underwater ecosystem as the underwater robot navigates from the starting point to the finish point; and provides the navigational path to the underwater robot.

### BACKGROUND

The present application relates generally to underwater inspection systems utilizing underwater robots or submersibles traveling from a starting point to an inspection location to perform an underwater inspection.

Sustainable underwater inspection of, for example, oil and gas pipes, is important because it helps to protect the environment, ensure safety, reduce costs, and comply with regulations, including protecting underwater and/or marine ecosystems. It would be advantageous to have a system and/or techniques that takes into consideration the impact to the environment when performing underwater inspections.

### SUMMARY

The summary of the disclosure is given to aid understanding of systems, platforms, tools, computer program products and/or techniques for performing underwater inspection and more specifically in one or more embodiments taking into consideration the environmental impact when performing an underwater inspection, including determining a navigational path to minimize the damage inflicted upon the ecosystem through which the underwater robot travels to perform the underwater inspection, and not with an intent to limit the disclosure or the invention.

A system, platform, computer programming product, and computer implemented method are disclosed for accessing the potential environmental impact when performing an underwater inspection of, for example oil and gas pipes, and determining a route and inspection procedure that would minimize the environmental impact to the surrounding environment and ecosystem. A system, platform, computer programming product, and/or method are disclosed that in one or more embodiments determines one or more potential navigational paths to be undertaken by an underwater robot when traveling from a starting point to a finish point; determines an impact area of the underwater robot for each potential navigational path based upon a size of the underwater robot and movement of the underwater robot along each respective potential navigational path; uses a marine habitat map to avoid sensitive areas in an underwater ecosystem along each of the one or more potential navigational paths; determines a navigational path from the one or more potential navigational paths that minimizes the potential environmental impact to the underwater ecosystem as the underwater robot navigates from the starting point to the finish point; and provides the navigational path to the underwater robot.

A system, platform, computer program product and/or computer implemented method is disclosed that in an embodiment includes determining an impact area of an underwater robot based upon its size and movement; using a marine habitat map to avoid sensitive areas in an underwater ecosystem while the underwater robot travels from a starting point to a finish point; generating a navigational path that minimizes environmental impact to the underwater ecosystem as the underwater robot navigates from the starting point to the finish point; and providing the navigational path to the underwater robot.

The foregoing and other objects, features and advantages of the invention will be apparent from the following more particular descriptions of exemplary embodiments of the invention as illustrated in the accompanying drawings.

### BRIEF DESCRIPTION OF THE DRAWINGS

The various aspects, features, and embodiments of methods, techniques, computer program products, platforms, tools, and/or systems for determining an optimized navigational path to minimize damage and/or impact to the underwater ecology while undergoing an underwater inspection will be better understood when read in conjunction with the figures provided.

Embodiments are provided in the figures for the purpose of illustrating aspects, features, and/or various embodiments of the methods, techniques, products, computer program products, platforms, tools and/or systems for determining an optimized navigational path to minimize damage to the underwater ecology while performing an underwater inspection, but the claims should not be limited to the precise arrangement, structures, features, aspects, assemblies, subassemblies, systems, platforms, circuitry, functional units, programming, instructions, code, embodiments, methods, processes, or devices shown.

FIG. 1 is an overview block diagram of an exemplary computing environment on which the present disclosure of determining an optimized navigational path to be undertaken by an underwater inspection robot to minimize the environmental impact inflicted by the underwater inspection can be practiced according to an embodiment.

FIG. 2 is an overview block diagram of an exemplary computing environment to implement the present disclosure of determining an optimized navigational path to take to minimize the environmental impact and/or damage inflicted by an underwater robot during an underwater inspection according to an embodiment of the present disclosure.

FIG. 3 is a flow chart showing an overview process of determining an optimized navigational path to take to minimize the damage to the environment when undergoing an underwater inspection by an underwater robot according to an embodiment of the present disclosure.

FIG. 4 shows an example diagrammatic representation of a display illustrating a number of potential navigational paths that can be undertaken by an underwater robot while performing an underwater inspection according to an embodiment of the present disclosure.

FIG. 5 is a schematic representation of an underwater robot equipped to perform an underwater inspection according to an arrangement of the present disclosure.

FIG. 6 is an example block diagram of a Sustainable Navigational Computation Module that can be used to compute a navigational path undertaken by an underwater robot while performing an underwater inspection that takes into consideration damage to the environment and marine ecosystem when performing the underwater inspection according to an embodiment of the present disclosure.

FIG. 7 depicts an example computing environment for execution of at least some of the computer code involved in determining a navigational path that takes into consideration the environment and marine ecosystem when calculating the navigational path to be undertaken by an underwater robot while performing an underwater inspection according to an embodiment of the disclosure.

### DETAILED DESCRIPTION

The following description is directed to a person of ordinary skill in the art, is made for illustrating the general principles of the invention, and is not meant to limit the inventive concepts claimed herein. In the following detailed description, numerous details are set forth in one or more embodiments in order to provide an understanding of methods, techniques, computer program products, platforms, tools, and systems for determining an optimized navigational path for an underwater robot to take while performing an underwater inspection, of, for example, underwater oil and gas pipes, that takes into consideration and minimizes the environmental damage to surrounding areas, however, it will be understood by those skilled in the art that different and numerous embodiments of the methods, techniques, computer program products, platforms, tools, and/or systems may be practiced without those specific details, and the claims and disclosure should not be limited to the arrangements, embodiments, features, aspects, systems, assemblies, subassemblies, structures, functional units, circuitry, programming, instructions, code, processes, methods, or details specifically described and shown herein.

In addition, features described herein can be used separately or in combination with other described features in each of the various possible combinations and permutations. Accordingly, variations and modifications may be made to the systems, platforms, tools, computer program products, techniques, and/or methods for determining an optimized navigational path to undertake to minimize environmental impact during an underwater inspection to achieve different effects. It may be noted that a numbered element in the figures is typically numbered according to the figure in which the element is introduced, is typically referred to by that number throughout succeeding figures, and that like reference numbers generally represent like parts of exemplary embodiments of the invention.

Unless otherwise specifically defined herein, all terms are to be given their broadest possible interpretation including meanings implied from the specification as well as meanings understood by those skilled in the art and/or as defined in dictionaries, treatises, etc. It should also be noted that, as used in the specification and the appended claims, the singular forms “a”, “an” and “the” include plural referents unless otherwise specified, and that the terms “includes”, “comprises”, and/or “comprising.” when used in this specification, specify the presence of stated features, integers, steps, operations, elements, and/or components, but do not preclude the presence or addition of one or more other features, integers, steps, operations, elements, components, and/or groups thereof.

Currently, there are no known sustainable underwater systems and/or techniques that take into consideration the amount of underwater damage and/or impact underwater inspection inflicts upon the environment or takes into account the carbon footprint of underwater inspections. Underwater inspection techniques and systems include underwater robots or submersibles that are equipped with sensors, cameras, and tools to detect oil underwater and to inspect if there are any oil or gas leaks in pipes. It would be advantageous to take into account the environmental impact when undertaking underwater inspections and perform sustainable underwater inspections. Performing sustainable underwater inspections requires careful planning and consideration of the environmental impact of such underwater inspections. Sustainable underwater inspections in one or more embodiments can include one or more of identifying the objectives of the underwater inspection, determining the scope of the underwater inspection determining the area of impact, determining an optimized route for minimizing the environmental impact, and accessing the environmental impact undertaken by the underwater inspection.

The proposed system, platform, computer program product and/or techniques in one or more embodiments will use historical navigation data, satellite imagery, research data, sensor data, weather data, and provide an underwater robot or submersible with an optimized path that takes sustainability factors into consideration. The proposed system, platform, computer program product and/or technique in an embodiment will use artificial intelligence (AI), machine learning, deep learning, and/or cognitive systems to generate an optimized navigational path that performs the desired search and inspection while taking into consideration the environmental impact to minimize environmental damage. Minimizing environmental damage in one or more embodiments includes minimizing the damage or effect to coral reefs, inhabitants (e.g., rare species) in the inspection area, the marine ecosystem, and the underwater sediments. The proposed system, platform, computer program product, and/or techniques in one or more embodiments will take into account the above factors to generate an optimal navigational path to perform underwater inspection and increase conservation and sustainability.

In an arrangement, the proposed system, platform, computer program product, and/or techniques in one or more embodiments will, given a starting point and an inspection location or finishing point, generate a navigational path for underwater robots or submersibles to follow with minimal impact to the underwater ecosystem. The proposed system, platform, computer program product, and/or techniques in one or more arrangements will generate recommendations for underwater robots while navigating from point-to-point for preserving coral reefs, aquatic life, rare species, marine ecosystems, and/or sediment. In an approach the proposed system, platform, computer program product, and/or technique uses at least one of machine learning, deep learning, artificial intelligence, cognitive learning to provide the recommended navigational paths for traveling from point to point with respect to conditions in the area to preserve coral reefs, aquatic life, rare species, and ecosystems.

The proposed system, platform, computer program product, and/or techniques in one or more embodiments will display the extent of destruction that the underwater robot and/or submersible would cause to the underwater ecosystem if it took a specified navigational path. That is the system will display the extent of potential damage to the environment that the underwater robot would inflict based upon the various different navigational paths, using for example color codes, graphics, or other visual aids to demonstrate the difference between the damage inflicted to the environment based upon various different navigational paths. For example, the best path (e.g., the path that would inflict the lowest environmental damage) could use green, while the worst navigational path could use red, while intermediate paths could use orange, or shades of orange/red. In an approach the proposed system, platform, computer program product and/or techniques in one or more embodiments calculate and compare the results, e.g., the damage inflicted, as a result of the navigational path undertaken to perform the underwater inspection to the potential damage that was calculated before the navigational path was undertaken (e.g., traveled) to perform the underwater inspection.

The proposed system, platform, computer program product and/or techniques in one or more approaches will assign weight percentage to sustainability, conservation, and efficiency and set the relative importance while generating the optimized route. In one or more embodiments, the proposed system, platform, computer program product and/or techniques in one or more embodiments will integrate with existing underwater navigational systems and provide a 360 degree view (photo/video) of the underwater journey along the navigational path and at the underwater inspection location, where in an approach the proposed system, platform, computer program product and/or techniques will display the sustainability and/or damage inflicted as the route is undertaken by the underwater robot.

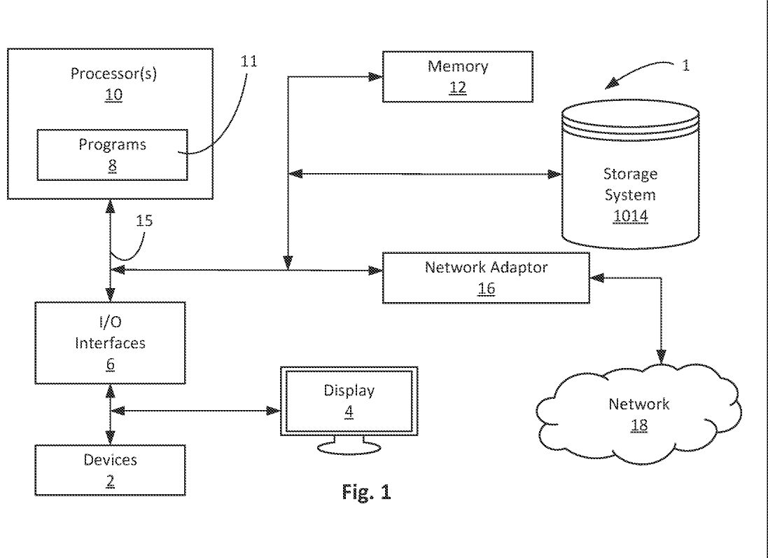

FIG. 1 illustrates an example computing environment 1 including for example a computing device and/or electronic data processing system 1 in which aspects of the present disclosure may be practiced. It is to be understood that the computing environment 1 depicted is only one example of a suitable computing and/or processing system and is not intended to suggest any limitation as to the scope of use or functionality of embodiments of the present invention. For example, the system shown may be operational with numerous other special-purpose computing system environments or configurations. Examples of well-known computing devices, systems, platforms, environments, and/or configurations that may be suitable for use in the present disclosure may include, but are not limited to, server computer systems, mainframe computers, distributed cloud computer systems, personal computer (PC) systems, PC networks, thin clients, thick clients, minicomputer systems, handheld or laptop devices, multiprocessor systems, microprocessor-based systems, smart phone, set top boxes, programmable consumer electronics, and the like that include or can access any of the above systems or devices, and the like.

It should be appreciated that the disclosed computing environments are only examples, and that the disclosure should not be limited to the specific computing environments disclosed. Furthermore, the following discussion omits or only briefly describes the computing environment, including the distributive computing environment, for example cloud computing environment which are apparent to those skilled in the art. It is assumed that those skilled in the art are familiar with computing environments including distributive computing environments, for example cloud computing and that those of skill in the art are also familiar with artificial intelligence (AI), machine learning (ML) models, cognitive analytics, and their application in accessing or analyzing data and relationship networks.

In some embodiments, the computing environment (e.g., computing device and/or system) 1 may be described in the general context of computer executable instructions, embodied as programs or program modules 8 (e.g., computer program product) stored in memory 12, being executed by the computer system. Generally, program modules may include routines, programs, objects, components, logic, data structures, and so on that perform particular tasks and/or implement particular input data and/or data types in accordance with the present invention.

The components of the computer environment 1 may include, but are not limited to, one or more processors or processing units 10, a memory 12, and a bus 15 that operably couples various system components, including memory 12 to processor 10. In some embodiments, the processor 10, which is also referred to as a central processing unit (CPU) or microprocessor, may execute one or more programs or modules 8 that are loaded from memory 12 to local memory 11, where the program module(s) embody software (program instructions) that cause the processor to perform one or more operations. In some embodiments, module 8 may be programmed into the integrated circuits of the processor 10, or loaded from memory 12, storage device 14, network 18 to local memory 11, and/or combinations thereof.

The processor (or CPU) 10 can include various functional units, registers, buffers, execution units, caches, memories, and other units formed by integrated circuitry, and may operate according to reduced instruction set computing (“RISC”) techniques. The processor 10 processes data according to processor cycles, synchronized, in some aspects, to an internal clock (not shown). Bus 15 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer device and/or system 1 may include a variety of computer system readable media, including non-transitory readable media. Such media may be any available media that is accessible by the computer system, and it may include both volatile and non-volatile media, removable and non-removable media.

Memory 12 (sometimes referred to as system or main memory) can include computer readable media in the form of volatile memory, such as random-access memory (RAM), cache memory and/or other forms, including non-volatile memory. Computing environment 1 can further include other removable/non-removable, volatile/non-volatile computer system storage media. By way of example only, storage system 14 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 15 by one or more data media interfaces.

The computer environment 1 may also communicate with one or more external devices 2 such as a keyboard, track ball, mouse, microphone, speaker, a pointing device, etc.; one or more devices that enable a user to interact with the computer system; any devices (e.g., network card, modem, etc.) that enable the computer system to communicate with one or more other computing devices, and/or one or more displays 4 that present information to a user. Such communication can occur via Input/Output (I/O) interfaces 6. Communications or network adapter 16 interconnects bus 15 with an outside network 18 enabling the computing environment 1 to communicate with other such systems. Additionally, an operating system such as, for example, AIX (“AIX” is a trademark of the IBM Corporation) can be used to coordinate the functions of the various components shown in FIG. 1.

The computing environment 1 can communicate with one or more networks 18 such as a local area network (LAN), a general wide area network (WAN), and/or a public network (e.g., the Internet) via network adapter 16. As depicted, network adapter 16 communicates with the other components of computing environment via bus 15. It should be understood that although not shown, other hardware and/or software components could be used in conjunction with the computing environment. Examples include, but are not limited to: microcode, device drivers, redundant processing units, external disk-drive arrays, RAID systems, tape drives, and data archival storage systems, etc.

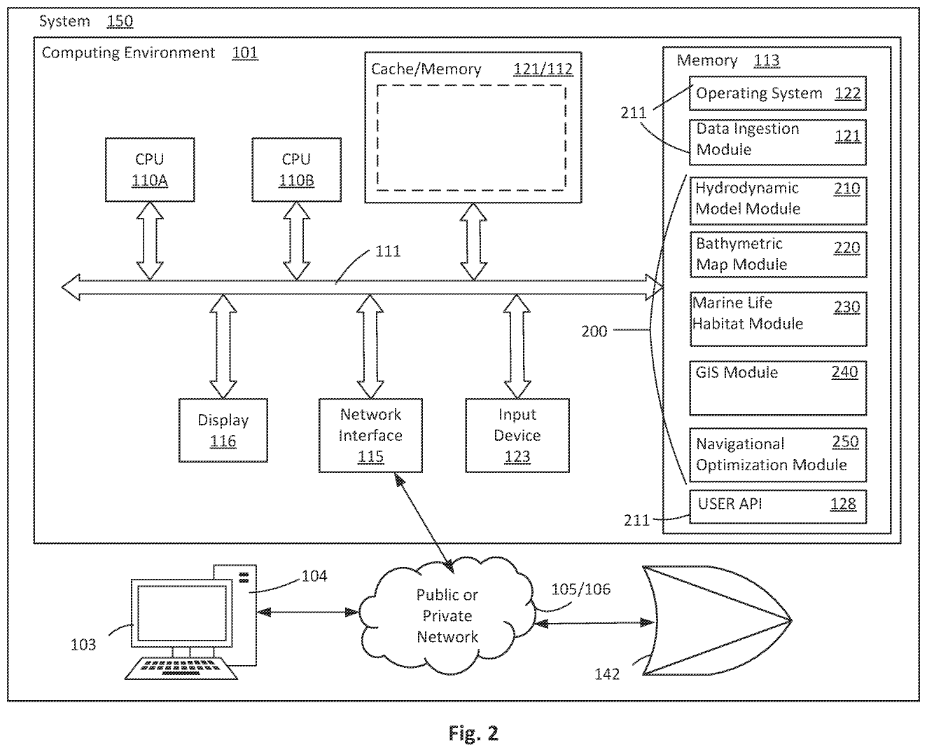

FIG. 2 illustrates a system 150, including a computing environment 101, configured and programmed to determine an optimized navigational path for an underwater robot to undertake while performing an underwater inspection that minimizes the environmental impact to the surrounding environment. According to an embodiment, computing environment 101 can be referred to as a master node 101, and master node can be part of a computing environment, including a computing system 150, that includes one or more worker nodes or end user devices 103. In one or more aspects, computing environment 101 can include, for example, mainframe computers, servers, distributed or cloud computing environments, thin clients, thick clients, personal computers, PC networks, laptops, tablets, mini-computers, multiprocessor-based systems, microprocessor-based systems, smart devices, smart phones, set-top boxes, programmable electronics, or any other similar computing device.

Computing environment 101 can include a cloud-based server, and can include one or more hardware processors 110A, 110B (also referred to as central processing units (CPUs)), a memory 113, e.g., for storing an operating system, application program interfaces (APIs) and programs, a network interface 115, a display device 116, an input device 123, and any other features common to a computing device, including a server. Further, as part of platform 101, there is provided a local cache/memory 121/112 and/or an attached memory storage device (not shown).

In one or more aspects, platform 101 may, for example, be any computing environment or device, including one or more web-based or cloud-based computing devices that are configured to communicate over a public or private communications network 105/106 with one or more user devices 103 (e.g., worker nodes 103). For instance, client user devices 103 can communicate with computing environment 101 where client user devices can include processing resources and memory (e.g., remote server) 104 that includes databases. Computing environment or Platform 101 in an approach is also configured to communicate, for example over a public or private network 105/106, with underwater robot or submersible 142. It can be appreciated that while only one underwater robot 142 is illustrated in FIG. 2, that multiple underwater robots 142 could be utilized in the system 150.

In the embodiment depicted in FIG. 2 processors 110A, 110B may include, for example, a microcontroller, Field Programmable Gate Array (FPGA), or any other processor that is configurable to perform operations according to instructions in software programs as described below. These instructions may be stored, for example, as programmed modules 211 in memory storage 113. Communication channels 111, e.g., wired connections such as data bus lines, address bus lines, Input/Output (I/O) data lines, video bus, expansion busses, etc., are shown for routing signals between the various components of computing environment 101.

Network interface 115 is configured to transmit and receive data or information to and from computing environment 101, e.g., via wired or wireless connections. For example, network interface 115 may utilize wireless technologies and communication protocols such as Bluetooth®, WIFI (e.g., 802.11a/b/g/n), cellular networks (e.g., CDMA, GSM, M2M, and 3G/4G/4G LTE, 5G), near-field communications systems, satellite communications, via a local area network (LAN), via a wide area network (WAN), or any other form of communication that allows computing device 103 and/or underwater robot 142 to transmit information to or receive information from computing environment 101.

Display 116 may include, for example, a computer monitor, television, smart television, a display screen integrated into a personal computing device such as, for example, laptops, smart phones, smart watches, virtual reality headsets, smart wearable devices, or any other mechanism for displaying information to a user. In one or more aspects, display 116 may include a liquid crystal display (LCD), an e-paper/e-ink display, an organic LED (OLED) display, or other similar display technologies. In one or more aspects, display 116 may be touch-sensitive and may also function as an input device. Input device 123 may include, for example, a keyboard, a mouse, a touch-sensitive display, a keypad, a microphone, a camera, or other similar input devices or any other input devices that may be used alone or together to provide a user with the capability to interact with the computing environment 101.

Memory 113 may include, for example, removable/non-removable, volatile/non-volatile storage media. Memory 113 may include, for example, non-transitory computer readable media in the form of volatile memory, such as random-access memory (RAM), non-volatile memory, cache memory and/or other memory. By way of non-limiting examples only, memory 113 may include a hard disk, a read-only memory (ROM), an erasable programmable read-only memory (EPROM or Flash memory), a compact disc read-only memory (CD-ROM), an optical storage device, a magnetic storage device, a portable computer diskette, a random-access memory (RAM), or any suitable combination of the foregoing.

Memory 113 of computing environment 101 stores one or more modules 211 that include, for example, programmed instructions adapted to determine outlier data using term patterns and/or correlations between term types, including in an example embodiment predicting the probability of an outlier claim using term patterns. In one embodiment, one of the programmed processing modules stored in memory 113 includes a data ingestion module 121 that provides instructions for employing logic and operating circuitry to access/read large amounts of data for use by other modules 211 that process and/or analyze the electronic data.

In one or more embodiments, computing system 150, including computing environment 101, e.g., memory 113, contains Sustainable Navigational Computation Module 200, which contains modules 211 for determining an optimal navigational path to reduce environmental impact during underwater investigation as discussed in detail herein. In an example embodiment, Sustainable Navigational Computation Module 200 contains a Hydrodynamic Model Module 210, a Bathymetric Map Module 220, a Marine Life Habitat Module 230, a Geographical Information System (GIS) Module 240, and a Navigational Optimization Module 250. The Hydrodynamic Model Module 210, the Bathymetric Map Module 220, the Marine Life Habitat Module 230, the Geographical Information System (GIS) Module 240, and the Navigational Optimization Module 250 will be described in greater detail below. It can be appreciated that portions or various modules 211 of the Sustainable Navigational Computation Module 200 can be distributed throughout computing environment 101 and/or system 150. For example, the programs (e.g., software applications/instructions) for use by the Sustainable Navigational Computation Module 200 can be stored outside Module 200 and can be distributed throughout computing environment 101 (e.g., Master Node 101) or in locations within computing system 150. Similarly, the artificial intelligence (AI), machine learning (ML) models, the deep learning models, and cognitive analytics utilized by the Sustainable Navigational Computation Module 200 can reside within Sustainable Navigational Computation Module 200, can be contained within one or more separate Machine Learning (ML) Modules, or be distributed throughout the System 150 and/or computing environment 101.

Computing environment 101 optionally includes a supervisory program having instructions to employ logic for configuring the processors 110, including the servers to call one or more, and in an embodiment all, of the program modules 211 and invoke the operations of system 150 and/or computing environment (master node) 101. In an embodiment, such supervisory program calls provide application program interfaces (APIs) for running the programs. At least one application program interface (API) 128 is invoked in an embodiment to perform data analytics including determining the optimized underwater navigational path to be undertaken while traveling from a starting point to a finish point by an underwater submersible to perform an underwater inspection that minimizes damage to the environment and/or marine ecosystem.

The system, computing environment, platform, tool, computer program product, method and/or techniques disclosed herein in one or more embodiments employ cognitive systems, machine learning, deep learning, and/or artificial intelligence programming and logic. As an overview, a cognitive system is a specialized computer system, or set of computer systems, configured with hardware and/or software logic (in combination with hardware logic upon which the software executes) to perform electronic data analytics and has the ability to emulate human cognitive functions. These cognitive systems apply, convey, and manipulate electronic data at various levels of interpretation which, when combined with the inherent strengths of digital computing, can solve problems with high accuracy and resilience on a large scale. IBM Watson™M is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured electronic data
Generate and evaluate hypotheses
Weigh and evaluate responses that are based only on relevant evidence
Provide situation-specific advice, insights, and guidance
Improve knowledge and learn with each iteration and interaction through machine learning (ML) models and processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
Provide a high degree of relevant recollection (memorization and recall) from data points (images, text, voice)
Predict and sense with situation awareness that mimics human cognition based on experiences
Answer questions based on natural language and specific evidence.

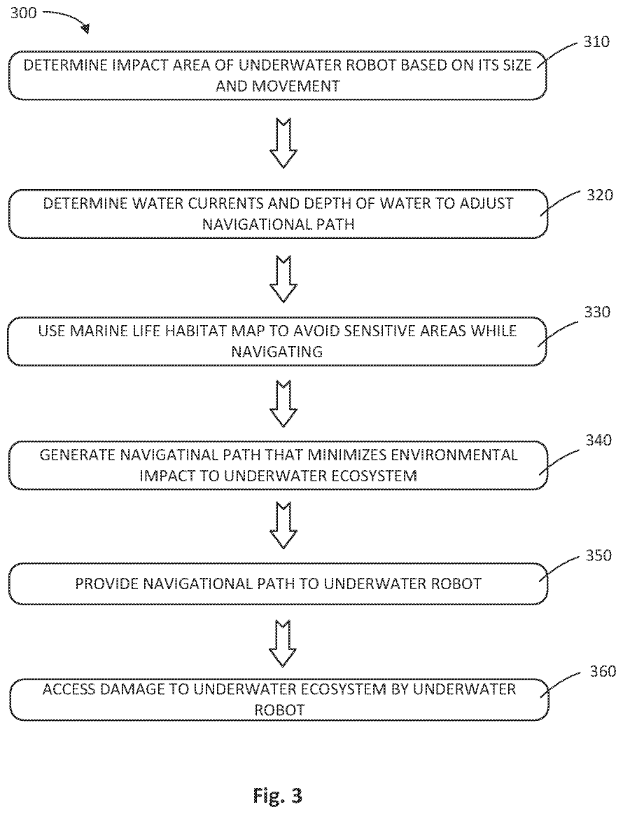

FIG. 3 outlines an exemplary flowchart in accordance with an embodiment illustrating and describing an overview method 300 of determining a navigational path to be taken by an underwater robot when performing underwater inspection that takes into consideration the environmental impact and in an approach determines a navigational path to undertake to perform an underwater inspection that minimizes the disruption or damage to the underwater habitat while undergoing the underwater inspection. In an example embodiment, for purposes of illustration, the method 300 can be used for determining the navigational path to undertake by an underwater robot (e.g., a submersible) while performing an underwater inspection, of for example oil and/or gas pipes, oil drilling rigs, and/or wind turbines located in bodies of water) that will minimize the environmental impact caused by the underwater inspection.

While method 300 will be described in connection with an oil rig and/or oil and gas pipelines, it can be appreciated that the method 300 and techniques described herein can be applied to other domains, for example, underwater inspection of turbines, boats, ships, shipwrecks, submerged aircraft, volcanos, fault lines, caves, bridges, dams, and/or other underwater objects and structures. In addition, while the method 300 is described for the sake of convenience and not with an intent of limiting the disclosure as comprising a series and/or a number of steps, it is to be understood that the process 300 does not need to be performed as a series of steps and/or the steps do not need to be performed in the order shown and described with respect to FIG. 3 but the process 300 can be integrated and/or one or more steps can be performed together, simultaneously, or the steps can be performed in the order disclosed or in an alternative order.

At 310 the impact area of the underwater robot is determined. In an approach, the impact area of the underwater robot is calculated based upon the size, e.g., the square footage or footprint, of the underwater robot, the speed of its travel, and distance of its navigational path from its starting point to its ending point (e.g., the location of the area to be inspected). At 310, impact area can be determined for the several potential navigational paths that can be undertaken by the underwater robot to travel from its starting point to the inspection location. In an aspect, the starting point “A” of the underwater robot and the inspection location “Z” or finishing point are inputs to the system, typically input by a user, and at 310 the distance of the navigational path from starting point “A” to the inspection location “Z” is determined and the impact area of the underwater robot is calculated based upon its size and movement.

In one or more embodiments, at 310 one or more potential navigational paths for the underwater robot to travel from the starting point “A” to the inspection location “Z” or finishing point are determined, and the impact area of the underwater robot is determined for the one or more potential navigational paths from starting point to the finish point is determined. It can be appreciated that the underwater robot can travel in three dimensions and that the one or more potential navigational paths are likely three dimensional as well. The number of potential navigational paths in likelihood could be plentiful and in one or more embodiments, the proposed system, platform, computer program product, and/or method uses a prioritization process to select the one or more potential navigational paths based upon at least one of a selection group consisting of: the travel distance along the potential navigational path, the energy efficiency (e.g., the lowest energy consumption) of the underwater robot travel along the potential navigational path, and combinations thereof. In other words, the proposed system, platform, computer program product, and/or process considers and prioritizes selection of the one or more potential navigational paths based upon those that provide the shortest distance, the best energy efficiency, and combinations thereof. Other selection criteria and techniques are contemplated for determining the one or more potential navigational paths for the underwater robot to travel from the starting point to the finish point.

At 320, in an embodiment, the system, platform, computer program product and/or method 300 uses one or more hydrodynamic models to predict the water currents along the potential navigational routes or paths from starting point “A” to inspection location “Z”. That is, in an embodiment at 320, Hydrodynamic Model Module 210 can be accessed to determine the water currents for the potential navigational paths from the starting Point “A” to the inspection location or finishing point “Z”. In a further approach, at 320 one or more bathymetric maps are used to determine the depth of the body of water, the submerged topography, and/or physiographic features of the bottom of the body of water (e.g., the ocean or sea bottom). That is, in an embodiment at 320, Bathymetric Map Module 220 can be accessed to determine the water depth and/or the bottom topography and/or features for the potential navigational paths from starting point “A” to the inspection location “Z”. At 320 the water currents and/or depth and water bottom features can be used to adjust the potential navigational paths that can be used to perform the underwater inspection. It can be appreciated that the hydrodynamic model and/or bathymetric maps can be updated, and in an embodiment can be updated by the submersible during (e.g., in real-time) or after the submersible travels through the marine environment (e.g., concludes its underwater inspection and downloads environment data).

In one or more approaches, at 330 the system can use a marine life habitat map to avoid sensitive areas while navigating. For example, at 330, locations that contain rare species of plant and/or animals can be identified, as well as locations where the terrain, sediment, and/or ecosystems that are sensitive, easily disrupted, and/or easily damaged can be identified. That is, at 330, according to an approach, Marine Life Habitat Module 230 can be accessed to determine and identify sensitive areas along the potential navigational paths to avoid. These locations containing rare plant life, rare animal species, fragile ecosystems and/or sediments can be avoided while navigating. That is, at 330, the potential navigational paths can be adjusted to avoid sensitive areas.

In an approach, different weights or scaling factors can be applied to different sensitive locations based upon the marine life and/or ecosystem in the locations. In a further embodiment, weighting can be assigned to environmental conservation and efficiency as the best or optimal navigational route or path to take might be a tradeoff between conservation and efficiency, where efficiency might be measured in an embodiment as the distance and/or energy utilized to travel the navigational path.

At 340, according to an embodiment, a geographic information system (GIS) is used to incorporate all the data and generate a navigational path from starting point “A” to inspection location “Z” to minimize the impact to the underwater ecosystem. That is, at 340, GIS module 240 can be accessed to incorporate all the data (e.g., the water currents, the depth of the water, the topography, and identified sensitive areas) to generate a navigational path that minimizes the ecological and/or environmental impact to the underwater ecosystem. In one or more embodiments, an optimization algorithm, which can be stored in Navigational Optimization Module 250 can be used to calculate and determine the optimized path from the starting point “A” to the inspection location or finishing point “Z”.

At 320, 330, and 340 the system determines the type and sensitivity of the marine environment in the impact area and calculates the amount of damage that would be inflicted and/or caused to the marine environment by the various potential navigational paths undertaken by the submersible from starting point “A” to inspection or finishing location “Z”, and further in an approach determines the navigational path that would provide the least damage to the underwater environment. In one or more approaches, a view of at least a portion or preferably the entire or complete navigational path from starting point to finish point of each of the potential navigational paths can be displayed for visualization by a user, for example by an actual or mock-up video.

In one or more embodiments, at 340 the environmental damage inflicted by the underwater robot by traveling along the potential navigational paths can be displayed, and in an approach can be displayed to a user (e.g., on a user computer 103) using color or other graphics to show the damage caused by the various different navigational paths. For example, the navigational path that provides or inflicts the least damage to the environment can be displayed in green, while alternative paths can be shown in other colors, for example red for the navigational path that would inflict the greatest damage to the environment, and different shades of orange to display navigational paths that provide intermediate damage to the environment (grades of damage less the worst navigational path and more damage than the optimal navigational path). Other graphical displays for illustrating the different potential navigational paths and the amount of damage inflicted by the different potential navigational paths are contemplated.

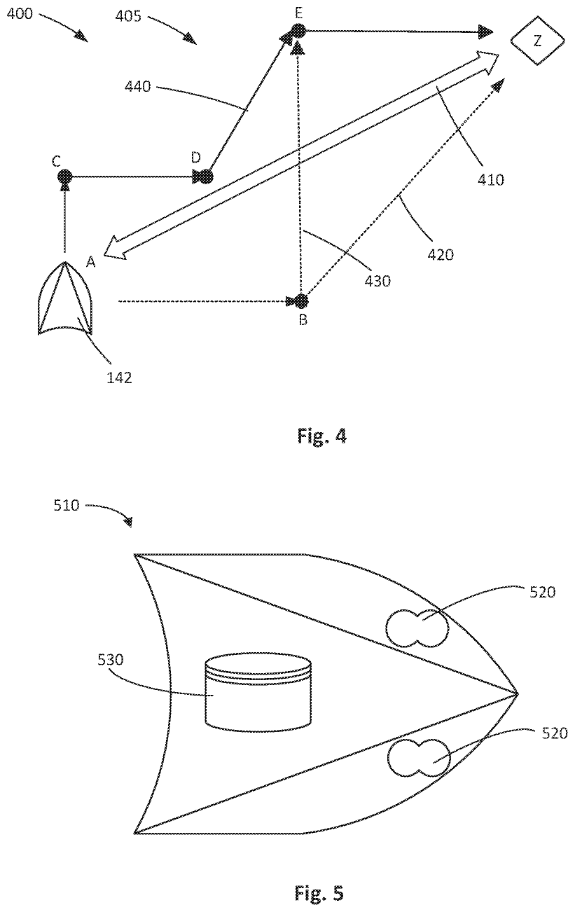

FIG. 4 is a schematic illustration of a display 400 provided to a user, which illustrates starting point “A” where the icon of the water robot 142 is located, inspection location or finishing point “Z”, and various or multiple potential navigational paths 405 that can be undertaken by the underwater robot when traveling between starting point “A” and inspection/finishing location “Z”. One potential navigational path 410 is illustrated by diagonal double arrow that goes along a straight and the shortest path between starting point “A” and location “Z”. Although navigational path 410 is the shortest distance and most direct route to the inspection location “Z”, it does not inflict the least amount of environmental damage while traveling to the inspection location “Z”, and would be displayed in a graphic that would indicate that it is not the most environmentally friendly navigational path. In FIG. 4, navigational path 410 inflicts the most environmental damage and in an embodiment would be illustrated by double arrow and might be shown in the color red (e.g., the double arrow filled in the color red).

A second navigational path 420 is shown in FIG. 4 which goes from starting point “A” to point “B” and then onto inspection location “Z”. Navigational path 420 is shown in dashed arrow to illustrate it is not the most environmentally friendly navigational path (e.g., does not inflict the least environmental damage) and to illustrate it is not the most environmentally unfriendly path (e.g., does not inflict the most environmental damage). Navigational path 420 in an embodiment could be illustrated in the color orange to indicate its intermediate status, and in an approach could be displayed as a double arrow filled in as orange. A third navigational path 430 is shown as a dashed arrow starting from point “A” and going to point “B”, then to point “E”, and then to the inspection location “Z”. Navigational path 430 is shown in dashed arrow to illustrate it is not the most environmentally friendly navigational path (e.g., does not inflict the least environmental damage) and to illustrate it is not the most environmental unfriendly path (e.g., does not inflict the most environmental damage). Navigational path 430 could be illustrated in the color orange to indicate its intermediate status, and in an approach could be displayed as a double arrow similar to navigational path 410 and filled in as orange to differentiate from navigational path 410.

A fourth navigational path 440 is shown in FIG. 4 which goes from starting point “A” to point “C” and then to point “D” and finally onto inspection location “Z”. Navigational path 440 is shown in solid single arrow to illustrate it is the most environmentally friendly navigational path (e.g., it inflicts the least environmental damage). Navigational path 440 could be illustrated in the color green to indicate it as the optimal navigational path. In an approach the navigational path 440 could be displayed as a double arrow similar to navigational path 410 but filled in with the color green to differentiate from the other potential navigational paths and indicating that it is the optimal path to inflict the least environmental damage.

The proposed system, platform, computer program product, and/or technique could determine the optimal navigational path to inflict the least environmental damage while traveling from starting point “A” to inspection/finishing location “Z” and could use the same navigational path in reverse to return to the starting point “A”. Alternatively, and/or in addition to, the proposed system, platform, computer program product, and/or technique could determine the optimal navigational path to return from inspection location “Z” to starting point “A” or other ending location “Q”. In this regard, the proposed system, platform, computer program product, and/or technique could determine the optimal navigational path to inflict the least environmental damage while traveling between any two points and in an approach, can be used to provide the optimal navigational path to inflict the least environmental damage while traveling between multiple points or locations where multiple inspections might be performed in a “single” trip.

FIG. 5 is a diagrammatic illustration of an underwater robot or submersible 510. Underwater submersible 510 contains propulsion systems (not shown) to provide thrust and/or propulsion to move the submersible 510 through and under water and/or direction systems (not shown) such as, for example, rudders and the like, to provide directional control through the water. The underwater robot or submersible 510 further contains sensors 520, such as, for example, temperature, speed, direction, location, pressure sensors; oil and or gas detection sensors; and/or cameras. Underwater robot or submersible 510 can contain lights and/or other features as well. Underwater robot or submersible 510 further contains computing and/or memory 530 to store navigational information as well as sensor data. Underwater robot 510 in an embodiment is underwater robot 142. It can be appreciated that while the system has been illustrated and discussed with one underwater robot 510/142, it can be appreciated that the system, platform, computer program product and/or technique can be applied and used with multiple underwater robots.

At 350 the navigational path is provided to the underwater robot. In one or more embodiments a user chooses the navigational path to provide to the underwater robot, and in an alternative approach the system can select and provide the underwater robot with the navigational path that inflicts the least environmental damage or use some other selection criteria to determine the navigational path to provide to the underwater robot. In one or more embodiments the navigational path at 350 is downloaded to and stored in memory in the underwater robot.

In one or more arrangements, the underwater robot performs the underwater inspection using the navigational path. During its progress along the navigational path the underwater robot can collect data such as for example, photos and/or video of the environment during the journey showing the environment before the underwater robot traverses the terrain/area, and/or showing the environment after the underwater robot traverses the terrain/area and the damage inflicted by the underwater robot. This collected data can be used to calculate and to determine the accuracy of the marine life habitat map, and to calculate and determine the amount of damage inflicted by the underwater robot during its journey. It can be appreciated that the underwater robot can be configured to provide a 360-degree view as it travels along its navigational path as well as at the inspection location. Other sensors can be used to collect other data such as pressure, temperature, currents, as well as speed of the underwater robot during its journey. Data including photos/video of the inspected object/structure and specimen samples (e.g., oil or gas readings) can be collected and stored. The data collected by the underwater robot can be stored in memory for later upload to the system or for real time uploading as the underwater robot undertakes its journey. Sample specimens can be carried back for further testing and inspection.

In one or more approaches, the data collected can be used to update the data used to determine the navigational route including in an embodiment updating the hydrodynamic model for the areas through which the navigational path traversed, the bathymetric map for the areas through which the navigational path traversed, the marine life habitat map for the areas through which the navigational path traversed, and the geographic information system for the areas through which the navigational path traversed. In one or more embodiments machine learning. cognitive learning, deep learning and/or artificial intelligence can be used to update and increase the knowledge base of the proposed system, platform, computer program product, and/or technique.

At 360 the system calculates and/or determines the actual damage inflicted to the environment. In one or more embodiments, at 360 the actual damage inflicted can be calculated using the data collected by the underwater robot during its journey to and from the inspection/finish location. In one or more embodiments, machine learning, cognitive learning, deep learning and/or artificial intelligence can use the calculations on the amount of damage inflicted by taking a particular navigational path to update and increase the knowledge base of the proposed system, platform, computer program product, and/or technique to provide continual improvements to the proposed system, platform, computer program product, and/or technique.

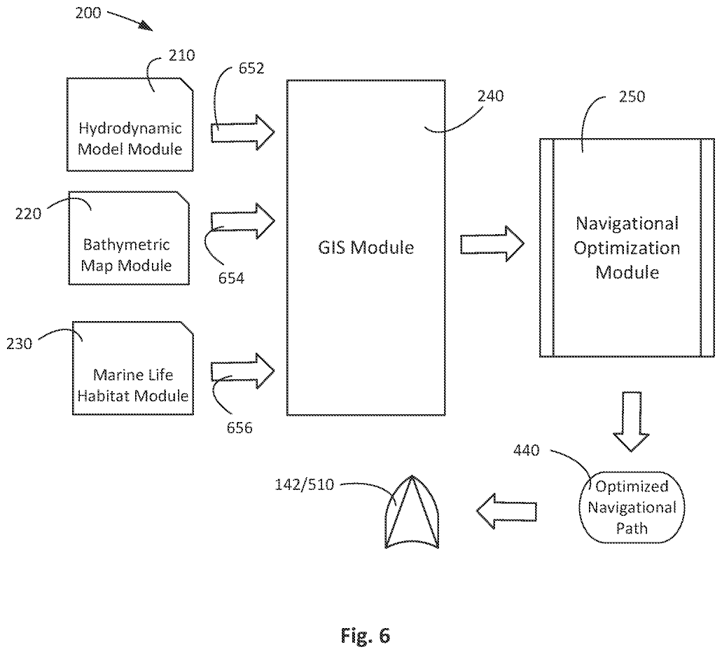

FIG. 6 is a diagrammatic illustration of the Sustainable Navigational Computation Module 200, which contains a Hydrodynamic Model Module 210, a Bathymetric Map Module 220, a Marine Life Habitat Module 230, a Geographical Information System (GIS) Module 240, and a Navigational Optimization Module 250 to determine and output an optimized navigational path 440. The Hydrodynamic Model Module 210, the Bathymetric Map Module 220, and the Marine Life Habitat Module 230 provide input 652, 654, 656 to the Geographical Information System (GIS) Module 240. The GIS Module 240 incorporates all the data received at least in part from the Hydrodynamic Model Module 210, the Bathymetric Map Module 220, and the Marine Life Habitat Module 230 and provides output to the Navigational Optimization Module 250. The Navigational Optimization Module 250 using an optimization algorithm can determine an optimized navigational path that in an arrangement is downloaded to and stored in the underwater robot 142/510. It can be appreciated that the database and/or libraries in Hydrodynamic Model Module 210, the Bathymetric Map Module 220, and the Marine Life Habitat Module 230 can be updated, including in an embodiment by the proposed system, platform, computer program product, and/or technique accessing information from other systems, platforms, computer program products, and/or databases including in an approach by other and/or multiple underwater robots.

A system, platform, computer program product and/or computer implemented method is disclosed that in an embodiment includes determining an impact area of an underwater robot based upon its size and movement; using a marine habitat map to avoid sensitive areas in an underwater ecosystem while the underwater robot travels from a starting point to a finish point; generating a navigational path that minimizes environmental impact to the underwater ecosystem as the underwater robot navigates from the starting point to the finish point; and providing the navigational path to the underwater robot. In an aspect, the system, platform, computer program product, and/or computer implemented method includes determining at least one of a water condition group for the navigational path, wherein the water condition group consisting of at least one of: water currents, depth of water, topography of underwater terrain, and combinations thereof; and using at least one of the condition group to adjust the navigational path. In an approach, determining the impact area of the underwater robot based upon its size and movement includes at least one, and in a further approach includes all, of an impact group consisting of: calculating a footprint of the underwater robot, calculating a potential navigational path to be undertaken by the underwater robot, using an intended speed of travel of the underwater robot in traveling the potential navigational path to be undertaken by the underwater robot, and combinations thereof.

The system, platform, computer program product, and/or computer implemented method in an embodiment further includes determining potential navigational paths to be undertaken by the underwater robot when traveling from the starting point to the finish point, and can additionally include using at least one of a calculation group consisting of at least one of: deep learning, machine learning, cognitive learning, and combinations thereof to determine the potential navigational paths to be undertaken by the underwater robot when traveling from the starting point to the finish point. In a further embodiment, the system, platform, computer program product, and/or computer implemented method further includes displaying a video or photograph of at least a portion of at least one of the potential navigational paths to be undertaken by the underwater robot when traveling from the starting point to the finish point. The system, platform, computer program product, and/or computer implemented method can optionally include accessing, after the underwater robot travels along the navigational path, the actual environmental impact inflicted by the underwater robot in traveling along the navigational path.

The system, platform, computer program product, and/or computer implemented method in an arrangement can also include displaying the potential navigational paths from the starting point to the finish point and using color to differentiate the potential navigational paths based upon the environmental impact inflicted by the respective potential navigational paths. In an embodiment the system, platform, computer program product, and/or computer implemented method can include displaying at least one of a visual group on a user display during at least a portion of the navigation path traveled by the underwater robot, wherein the visual group comprises of at least one consisting of: a video, a photograph, and combinations thereof.

In one or more embodiments a system, platform, computer programing product, and/or method can include and/or configure at least one hardware processor to: determine one or more potential navigational paths to be undertaken by an underwater robot when traveling from a starting point to a finish point; determine an impact area of the underwater robot for each potential navigational path based upon a size of the underwater robot and movement of the underwater robot along each respective potential navigational path; use marine habitat map to avoid sensitive areas in an underwater ecosystem while the underwater robot travels along each of the one or more potential navigational paths; determine a navigational path from the one or more potential navigational paths that minimizes environmental impact to the underwater ecosystem as the underwater robot navigates from the starting point to the finish point; and provide the navigational path to the underwater robot.

The system, platform, computer program product, and/or system can include and/or configure at least one hardware processor to display a video or photograph of at least a portion of at least one of the one or more potential navigational paths to be undertaken by the underwater robot when traveling from the starting point to the finish point, and in an approach can include and/or configure the at least one hardware processor to use at least one of a calculation group consisting of at least one of: deep learning, machine learning, cognitive learning, and combinations thereof to determine the one or more potential navigational paths to be undertaken by the underwater robot when traveling from the starting point to the finish point. The system, platform, computer program product, and/or method can include and/or configure the at least one hardware processor to display the one or more potential navigational paths from the starting point to the finish point and using color to differentiate the one or more potential navigational paths based upon the environmental impact inflicted by the respective one or more potential navigational paths. In an embodiment, determining one or more potential navigational paths to be undertaken by an underwater robot when traveling from a starting point to a finish point can include and/or configure, in an embodiment the at least one hardware processor to calculate the one or more potential navigational paths by prioritizing potential navigational paths based upon at least one of a selection group consisting of: the distance of the potential navigational path, the energy efficiency of the potential navigational path, and combinations thereof.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

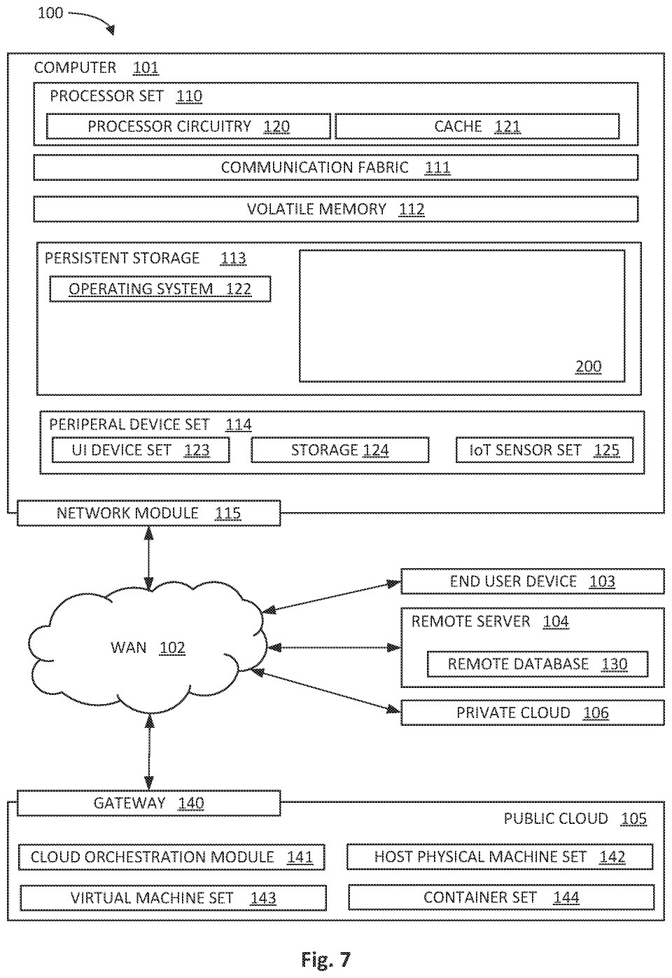

Computing environment 100 of FIG. 7 contains an example of an environment for the execution of at least some of the computer code involved in performing the inventive methods, such as determining whether there is outlier data by using term patterns, including in an example embodiment new code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 7. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods. This code and its operation has been described in connection with the example Sustainable Navigational Computation Module 200 for determining a navigational path to be undertaken by an underwater robot or submersible that takes into consideration the environmental impact inflicted by the underwater robot undertaking an underwater inspection operation, and in an embodiment determining an optimized navigational path that provides the least environmental impact and destruction.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, the method comprising:
determining an impact area of an underwater robot based upon its size and movement;
using a marine habitat map to avoid sensitive areas in an underwater ecosystem while the underwater robot travels from a starting point to a finish point;
generating a navigational path that minimizes environmental impact to the underwater ecosystem as the underwater robot navigates from the starting point to the finish point; and
providing the navigational path to the underwater robot.

2. The method of claim 1, further comprising:
determining at least one of a water condition group for the navigational path, wherein the water condition group consisting of at least one of: water currents, depth of water, topography of underwater terrain, and combinations thereof; and
using at least one of the condition group to adjust the navigational path.

3. The method of claim 1, wherein determining the impact area of the underwater robot based upon its size and movement comprises at least one of an impact group consisting of:
calculating a footprint of the underwater robot, calculating a potential navigational path to be undertaken by the underwater robot, using an intended speed of travel of the underwater robot in traveling the potential navigational path to be undertaken by the underwater robot, and combinations thereof.

4. The method of claim 3, wherein determining the impact area of the underwater robot based upon its size and movement comprises using each one of the impact group.

5. The method of claim 1, further comprising determining potential navigational paths to be undertaken by the underwater robot when traveling from the starting point to the finish point.

6. The method of claim 1, further comprising displaying a video or photograph of at least a portion of at least one of the potential navigational paths to be undertaken by the underwater robot when traveling from the starting point to the finish point.

7. The method of claim 1, further comprising using at least one of a calculation group consisting of at least one of: deep learning, machine learning, cognitive learning, and combinations thereof to determine the potential navigational paths to be undertaken by the underwater robot when traveling from the starting point to the finish point.

8. The method of claim 1, further comprising accessing, after the underwater robot travels along the navigational path, the actual environmental impact inflicted by the underwater robot in traveling along the navigational path.

9. The method of claim 1, further comprising displaying the potential navigational paths from the starting point to the finish point and using color to differentiate the potential navigational paths based upon the environmental impact inflicted by the respective potential navigational paths.

10. The method of claim 1, further comprising displaying at least one of a visual group on a user display during at least a portion of the navigation path traveled by the underwater robot, wherein the visual group comprises of at least one consisting of: a video, a photograph, and combinations thereof.

11. A computer programing product comprising instructions that, when executed by at least one hardware processor, configure the at least one hardware processor to:
determine one or more potential navigational paths to be undertaken by an underwater robot when traveling from a starting point to a finish point;
determine an impact area of the underwater robot for each potential navigational path based upon a size of the underwater robot and movement of the underwater robot along each respective potential navigational path;
use marine habitat map to avoid sensitive areas in an underwater ecosystem while the underwater robot travels along each of the one or more potential navigational paths;
determine a navigational path from the one or more potential navigational paths that minimizes environmental impact to the underwater ecosystem as the underwater robot navigates from the starting point to the finish point; and
provide the navigational path to the underwater robot.

12. The computer program product according to claim 11, further comprising instructions that, when executed by the at least one hardware processor, configure the at least one hardware processor to:
determine at least one of a water condition group consisting of at least one of: water currents, depth of water, topography of underwater terrain, and combinations thereof; and
use at least one of the condition group to adjust the one or more potential navigational paths.

13. The computer program product according to claim 11, wherein determining the impact area of the underwater robot based upon its size and movement comprises instructions that, when executed by the at least one hardware processor, configure the at least one hardware processor to perform at least one of an impact group consisting of: calculating a footprint of the underwater robot, using an intended speed of travel of the underwater robot in traveling the one or more potential navigational paths to be undertaken by the underwater robot, and combinations thereof.

14. The computer program product according to claim 11, wherein determining the impact area of the underwater robot based upon its size and movement comprises instructions that, when executed by the at least one hardware processor, configure the at least one hardware processor to perform both of the impact group.

15. The computer program product according to claim 11, further comprising instructions that, when executed by the at least one hardware processor, configure the at least one hardware processor to display a video or photograph of at least a portion of at least one of the one or more potential navigational paths to be undertaken by the underwater robot when traveling from the starting point to the finish point.

16. The computer program product according to claim 11, further comprising instructions that, when executed by the at least one hardware processor, configure the at least one hardware processor to use at least one of a calculation group consisting of at least one of: deep learning, machine learning, cognitive learning, and combinations thereof to determine the one or more potential navigational paths to be undertaken by the underwater robot when traveling from the starting point to the finish point.

17. The computer program product according to claim 11, further comprising instructions that, when executed by the at least one hardware processor, configure the at least one hardware processor to access, after the underwater robot travels along the navigational path, the actual environmental impact inflicted by the underwater robot in traveling along the navigational path

18. The computer program product according to claim 11, further comprising instructions that, when executed by the at least one hardware processor, configure the at least one hardware processor to display the one or more potential navigational paths from the starting point to the finish point and using color to differentiate the one or more potential navigational paths based upon the environmental impact inflicted by the respective one or more potential navigational paths.

19. The computer program product according to claim 11, wherein determining one or more potential navigational paths to be undertaken by an underwater robot when traveling from a starting point to a finish point comprises instructions that, when executed by the at least one hardware processor, configure the at least one hardware processor to calculate the one or more potential navigational paths by prioritizing potential navigational paths based upon at least one of a selection group consisting of: the distance of the potential navigational path, the energy efficiency of the potential navigational path, and combinations thereof.

20. The computer program product according to claim 11, further comprising instructions that, when executed by the at least one hardware processor, configure the at least one hardware processor to display at least one of a visual group on a user display during at least a portion of the navigation path traveled by the underwater robot, wherein the visual group comprises of at least one consisting of: a video, a photograph, and combinations thereof.
